(19) United States
(12) Patent Application Publication
(10) Pub. No.: US 2013/0342846 A1
(43) Pub. Date: Dec. 26, 2013

(54) DEVICE AND METHOD FOR ULTRASONIC NONDESTRUCTIVE TESTING USING A LASER

(71) Applicants: Benjamin Campagne, Saint Herbalin (FR); Hubert Voillaume, Issy Les Moulineaux (FR)

(72) Inventors: Benjamin Campagne, Saint Herbalin (FR); Hubert Voillaume, Issy Les Moulineaux (FR)

(73) Assignee: European Aeronautic Defense and Space Company EADS France, Paris (FR)

(21) Appl. No.: 13/984,902

(22) PCT Filed: Feb. 14, 2012
(86) PCT No.: PCT/EP2012/052481

§ 371 Date: Sep. 10, 2013

(30) Foreign Application Priority Data
Feb. 14, 2011 (FR) 1151183

(51) Int. Cl. G01N 21/88

(52) U.S. Cl. CPC G01N 21/8806
USPC 356/450; 356/237.1

(57) ABSTRACT

Device and method for the nondestructive testing of a part made of a composite material reinforced with fibers, the device including: a) an energizing laser beam generator and elements for producing a photoelastic stress pattern of the surface of the part, in an energizing area, using the laser beam; b) elements for generating a first detection laser beam capable of illuminating the part in a target area; c) elements for generating a second reference detection laser beam, whose characteristics can be controlled independently of those of the detection laser beam; d) a two-wave photoreactive detector including a photorefractive crystal pumped by the reference laser beam; e) elements for collecting the beam reflected by the target area of the first detection laser and conveying the beam into the photorefractive detector; and f) elements for modifying the characteristics of the reference laser so as to adjust the bandwidth of the photorefractive detector.

The invention concerns a device and a method for ultrasonic non-destructive testing using a laser. The invention is more particularly adapted to the testing of a structural workpiece made from fibrous reinforced composite material, the said workpiece comprising notably of assemblies according to various bonding and soldering techniques. For purpose of an example, non-limiting, the device and the method according to the invention allows the testing of workpieces including composite panels assembled in honeycombs, or coated composite structures, coatings such as ceramic layers. The applications of the invention are mainly, but not exclusively, adapted to testing large structural workpieces in the aeronautic or aerospace domain.

It is known from prior art, to use non-destructive testing techniques based on the analysis of the propagation of ultrasonic waves in an environment making up an workpiece. The testing devices of this type comprise of means of generating an ultrasonic wave, coupled acoustically with the workpiece, to transmit a mechanical wave there, and means of detection to measure the characteristics of propagation of this wave. The presence of discontinuities in the environment of propagation creates echoes or reductions of the wave, these discontinuities can thus be detected. Examples of discontinuities are holes, delamination, variations of density etc. The adjustment of the sensitivity of detection allows the detecting of discontinuities likely to show damaging faults in the quality of the thus tested workpiece. The frequency of the ultrasonic wave also allows the differentiation of discontinuities according to their nature.

In the case of a workpiece comprising of assemblies, there are actually discontinuities of the interfaces between different elements making up the assembly. Thus, it is difficult to test the presence of faults, or discontinuities, inside the assembled elements and the cohesion of the assembly interface, which are not shown by the same wave frequencies, during the same operation. Thus, faults of cohesion to the interfaces influence the propagations of long wavelengths, that is to say low frequencies, in the kilohertz range (10³ Hertz or kHz), while the intrinsic faults of the workpieces influence rather the propagations of the short wavelengths, that is to say high frequencies around the megahertz (10⁶ Hertz or MHz). There is a correlation between the average dimension of the faults detected and the wavelength of the acoustic signal which allows their detection.

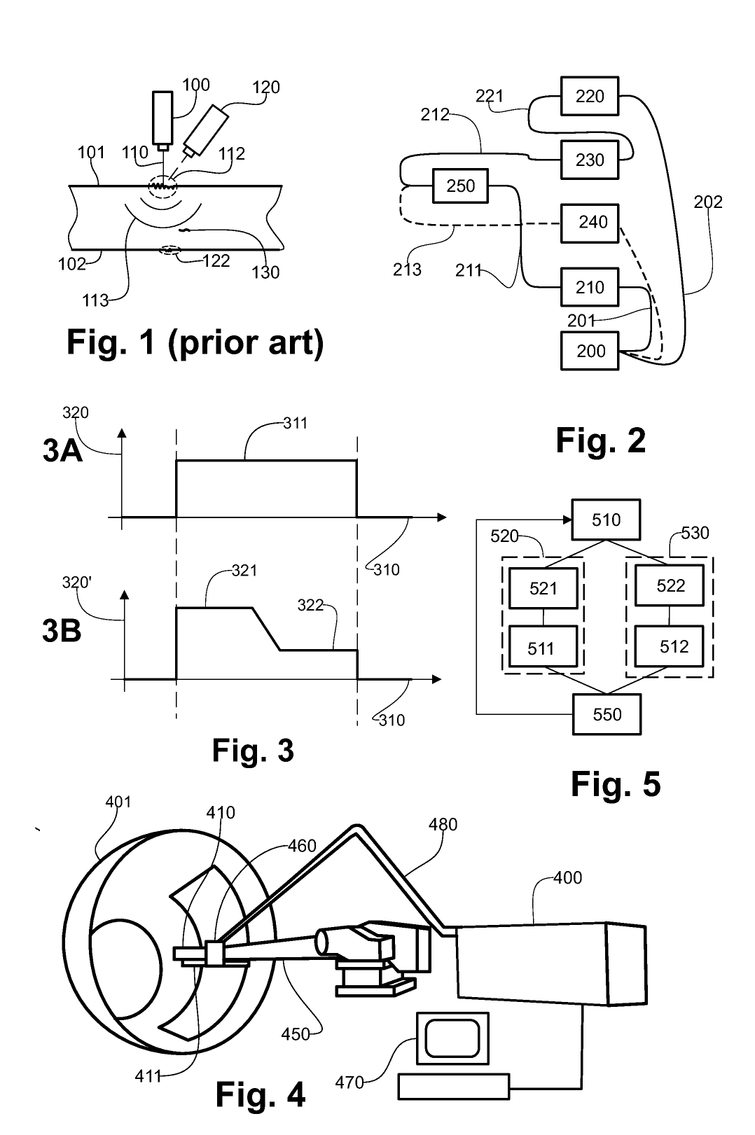

It is also known from prior art, to use a photoelastic impulse on the surface of the workpiece, by means of a laser beam, known as excitation laser beam, to generate the ultrasonic wave. FIG. 1, relating to prior art, diagrammatically illustrates this principle. The ultrasonic testing of a workpiece by this process consists of producing a localised disturbance (112) to the surface (101) of a workpiece (100) by photoelastic effect, exposing a small surface of the workpiece to the energy released under impulsive form by an excitation laser beam (110) generated by an adapted source (100), for example a TEA CO₂ type laser. This disturbance of the surface (101) produces a mechanical wave (113) which is propagated elastically in the workpiece, at the speed of sound in the environment making up the said workpiece. The impulsive excitation of the surface creates contact on the workpiece according to a large spectrum of frequencies. A second laser beam, known as detection, illuminates the surface in the target area, generally close to or merged with the excitation area, according to a given duration of impulsion. The beam is reflected by the surface and modified by the surface's vibrations, which can be measured by an interferometer. In presence of a fault (130) inside of the workpiece, a section of the elastic wave (113) will reflect itself on this fault (130), a reflected wave which, by propagating itself, reaches the emission surface (101) once again, where it can be detected by the measuring device (120), in the same way as this measuring device (120) detects the base echo, corresponding to the reflection of the elastic wave (113) on the surface opposite (102) to the workpiece (100). The reflected wave on the fault (130) meets the emission surface (101) before the base echo, so that the measuring of a disturbance of the surface (101) before the return of the base echo proves the presence of a discontinuity, and the measuring of time separating the measurement of this surface distortion at the time of the initial impulsion (112) allows to determine the depth of the fault (130) in relation to the emission surface (101). The analysed acoustic wavelengths depend on the impulsion of the detection beam and the bandwidth of the interferometer.

It is also known that the prior art of using a two-wave photorefractive interferometer, commonly designed by TWM interferometer, as an acronym of the English expression, “Two Wave Mixing”. This type of interferometer uses a photorefractive crystal, the crystal being excited, or pumped, by a beam known as reference beam. The reflection of the detection signal beam on the surface of the workpiece is also directed towards the photorefractive crystal or the two beams are disturbed. For this purpose, a small part of the power of the detection beam is directed to be used as a pump for the TWM interferometer. The use of one part of the detection laser beam itself as a reference, allows to always have a reference available, consistent with the said detection laser beam. The TWM interferometer has the advantage of having a distinctly constant sensitivity over a large range of frequency, from kHz to MHz. Thus, by adjusting the characteristics, particularly the intensity, of the reference signal beam, it is possible to measure the response of the workpiece to the excitation produced by the excitation beam for different ranges of frequency and, consequently, to test the assembled workpieces, as much as on the planar of their intrinsic faults, at a high frequency, as on the planar of the cohesion of assembly interfaces to the lowest frequency. Later, faults such as delamination of fibres for a workpiece made from composite material, known as intrinsic faults, are conventionally shown, as they are located inside of a same workpiece and are detected by the analysis of frequency in the MHz domain, according to an ordinary and common technique in the non-destructive testing by ultrasound. By interface cohesion we mean faults which are produced particularly on the interface between two environments or two different workpieces, the faults being commonly detected by non-destructive testing at a low frequency, commonly shown by the English term of “Tap Testing”. This non-destructive testing consists of applying stress to the structure by an impact using a lightweight hammer, generally instrumented, and by analysing the acoustic response, either by ear, or by spectrum analyser, by comparing the response of the stress-applied structure with that of a reference structure. This procedure allows the detection of cohesion faults which affect the acoustic response of the structure in its entirety, that is to say, in a range of frequency in the kHz region.

According to this method of the prior art, a first scanning of the workpiece is, for example, carried out by using a high frequency detection, then, the characteristics of the detection beam are modified, in order to carry out a low frequency detection, and a new scanning of the workpiece is carried out with these new conditions.

The document US 2008/0316498 describes a device and a method for the non-destructive testing of a workpiece, notably made from a composite material, wherein the method uses ultrasound generated by a laser impulse on the surface of the workpiece, and means of generating a detection laser beam and a reference laser beam, using the same source.

The document US 2009/0168074 describes a method and a device suitable for carrying out a “tap test” type test, from an excitation by a laser impulse of the surface.

None of these methods or devices of prior art provides a method or a device for the simultaneous carrying out of the two types of tests during a same illumination of the area targeted by the test.

The invention consists of a device for the non-destructive testing of an workpiece, notably made from a fibrous reinforced composite material, which the device includes:
a. a generator of a laser beam known as excitation laser beam generator, and means to produce a photoelastic stress pattern of the surface of the workpiece, in an excitation area, using this laser beam;
b. means for generating a first laser beam, known as detection laser beam, suitable to illuminate the workpiece in a target area;
c. means for generating a second detection laser beam, known as reference laser beam, one characteristic of which can be adjusted independently of the characteristics of the detection laser beam;
d. a two-wave photorefractive detector, comprising of a photorefractive crystal pumped by the reference laser beam;
e. means for collecting the reflected beam by the target area of the first detection laser and conveying the reflected beam into the photorefractive detector;
f. means of generation including a single source made up of a monolithic stabilised single-frequency oscillator, of the Nd:YAG type, pumped by diode, and two distinct amplifier lasers, to generate, from this source, the detection laser beam (211) and the reference laser beam (221).
g. means for modifying at least one characteristic of the reference laser, in order to adjust the bandwidth of the photorefractive detector between a first low cut-off frequency higher than 1 MHz and a second low cut-off frequency lower than 10 kHz.

Thus, the workpiece that is the subject of the invention, allows to vary the characteristics of the reference laser beam used as a TWM detector pump, without modifying the characteristics of the detection beam, so that the detection at a high frequency and the detection at a low frequency can be carried out one after the other in a very short space of time during the same measurement. A single scan then allows to completely test the assembled workpiece so that the productivity of the device is at least double that of the devices known from prior art. The type of source allows to release a very stabilised frequency, and is thus particularly well adapted as master laser for a later single-frequency amplification, and in the case of the device that is the subject of the invention, for a double amplification. This type of source is also adapted for use in a Fabry-Pérot confocal type interferometer. Thus, these characteristics are advantageously built on to generate the two laser beams, that is of detection and of reference, from the two distinct amplifiers of the said source. Thus, by coming from a unique laser source, the device that is the subject of the invention, allows to generate three types of detection beams, allowing to use, according to the circumstances and the envisaged type of measurement, a confocal interferometer or the TWM interferometer, and by modifying, if necessary, the bandwidth of the TWM interferometer, and all in an automatic way.

The invention can be implemented according to the advantageous embodiments exposed hereinafter, which can be considered individually or according to every technically operating combination.

Advantageously, the device that is the subject of the invention includes scanning means to move the excitation laser beam and the first detection laser beam at the surface of the workpiece in order to carry out a scanning of its surface. It is remarkable that the device that is the subject of the invention does not modify the part carrying out the scan of the surface of the workpiece, so that the device that is the subject of the invention can be easily adapted to a testing device of the prior art, by adding means to generate and drive the reference laser beam in order to test the pumping of the photorefractive crystal. These means are fixed and do not modify the head of the scanning of an installation conventionally including an excitation laser and a detection laser.

Advantageously, the means of modification of the reference laser beam act on the intensity of the said beam. Thus, the modification of the measuring conditions is carried out in a simple way by driving the amplification of the reference laser beam.

According to an advantageous embodiment, the device that is the subject of The invention includes, additionally, a Fabry-Përot confocal type interferometer. This type of interferometer does not show as large a range of measuring frequencies as the TWM interferometer, on the other hand, it is more precise and more sensitive than it, and allows particularly the carrying out of measurements relating to the presence of intrinsic faults.

The invention also concerns a method of non-destructive testing for the testing of a workpiece, notably made from a fibrous reinforced composite material, using the device that is the subject of the invention, according to any one of its embodiments exposed above, and including the following steps:
a. producing a photoelastic excitation on the surface of the workpiece using the excitation laser;
b. measuring the response to this excitation in the target area illuminated by the detection laser beam by pumping the photoreactive interferometer with a reference signal so that the measurement is carried out with a first low cut-off frequency higher than 1 MHz;
c. modifying the reference beam in order to carry out an interferometric measurement using the photorefractive interferometer with a second cut-off frequency lower than the first cut-off frequency;
   the illumination (311) of the target area by the detection laser beam being continued during the steps a/ to c/.

Thus, the combination of the device and the method that are the subject of the invention allows the carrying out in a measurement point different types of tests, by optimising the cut-off frequency to detect particular faults, these measurements being carried out in a same sequence of illumination of the target area by the detection laser. Thus, the measurement being quick, the method that is the subject of the invention allows to reach a heightened productivity for the testing of a workpiece, likely to make the two types of concerned faults appear.

Advantageously, the second cut-off frequency is less or equal to 10 kHz. Thus, it is possible to combine a test by ultrasound of the intrinsic faults and a test of the cohesion of the interface at a same measurement point, and this in an automated way.

Advantageously, the steps a/ to c/ of the method that is the subject of the invention, are repeated for a second point on the surface of the workpiece. Thus, besides the fact of automating the measurement, this cooperation between the device and the method allows to resolve one of the main shortfalls of the prior art, concerning the testing by the overall acoustic response, to know that this way of testing is, above all else, considered as qualitative as it does not allow the qualification of the size of the cohesion faults detected, and their localisation. The taking of measurement with an analysis according to the multiple ranges of frequency and over numerous points of the workpiece, in an automated way, opens up the possibility, by a computerised processing of the signal, to draw up a complete cartography of intrinsic faults as well as the cohesion of the interface.

According to an advantageous embodiment, the method that is the subject of the invention, includes a step involving measuring the response of the workpiece in the target area with the Fabry-Pérot type interferometer with a low cut-off frequency higher than or equal to 1 MHz.

The invention is described hereinafter according to its preferred embodiments, not limitative, and in reference to FIGS. 1 to 5 wherein:

FIG. 1 relating to the prior art diagrammatically represents full-face and sectional, the principle of a non-destructive testing device by ultrasound of an workpiece using a photoelastic impulse for excitation on the surface of the said workpiece and a detection laser pointed on the same surface to measure its response;

FIG. 2 is a synoptic diagram of an embodiment of the device that is the subject of the invention;

FIG. 3 represents the diagrams of the functioning of the detection laser and of the reference laser used to pump the photorefractive crystal of the TWM detector;

FIG. 4 shows an example of embodiment in the perspective of the device that is the subject of the invention used for the testing of an assembled aeronautic structure;

FIG. 5 represents a flow diagram of the method that is the subject of the invention.

FIG. 2, according to an example of embodiment, the detection device that is the subject of the invention includes a monolithic oscillator (200) at a single frequency or MISER for an English acronym of “Monolithic Isolated Single-mode End-pumped Ring”, known from the prior art. Typically, this oscillator uses an Nd:YAG crystal, pumped by diode of a wavelength of 1.064 μm (1.064.10⁻⁶m). This very stable source, of a power of around 200 mW, is used as a master laser, and is directed towards two distinct laser amplifiers (210, 220). The first amplifier is preferentially a flash lamp system in an Nd:YAG bar. It receives more than 95% of the power (201) of the master laser and supplies the detection laser (211) after amplification. The said detection laser (211) delivers impulses of 30.10⁻⁶ to 300.10⁻⁶ seconds for an energy of around 50.10⁻³.J by impulse. This detection laser beam (211) illuminates the target area on the surface of the workpiece according to a mark of a diameter of around 5 mm, it is directed towards the scanning means (250), where it follows the excitation laser beam. The reflection (212) of the detection laser (211) by the surface of the workpiece is collected and directed towards the TWM interferometer (230).

The second amplifier is preferentially a fibre amplifier, pumped by diode laser in a Yb:YAG doped fibre optic. It receives less than 5% of the initial power (202) of the master laser. The resulting laser beam (221) is used as a reference laser beam, directed towards the TWM interferometer (230).

Alternatively, the reflection (213) of the detection laser on the surface of the workpiece can be collected and directed towards a Fabry-Përot confocal type interferometer (240).

FIG. 3, the observation of the variation of intensity (320, 320′) of the detection laser beam (311), FIG. 3A, and of the reference laser beam (321, 322), FIG. 3B, in accordance with the time (310), shows the synchronised driving of the two lasers during an impulse of the master laser. During such an impulse, and according to this example of embodiment, the detection laser illuminates the workpiece in the target area, according to a significantly constant intensity (320), so the quantity of light reflected by the surface is always sufficient to ensure the measurement. On the other hand, the intensity of the reference laser, used as a pump of the photorefractive crystal of the TWM detector, is guided and, for example, used at its maximum intensity (321) during the first part of the detection laser impulse, then at a weaker intensity (322) during another part of the impulse (311) of the detection laser. Thus, during the said first part (321), the TWM interferometer will show a heightened low cut-off frequency, around the MHz region, and will be used for revealing intrinsic faults of the tested workpiece, then, during the said second part (322), the low cut-off frequency of the interferometer is reduced, in the kHz range, and so allows to reveal the cohesion faults of the assembly, tested according to a method being a part of tap testing. During all of this impulse (311), the intensity of illumination of the target area is continued. According to a preferential embodiment, the intensity of illumination of the target area is distinctly constant, but other profiles of intensity of illumination can be used.

FIG. 4, according to an example of embodiment, the device that is the subject of the invention is adapted to the non-destructive testing according to the two simultaneous methods of large workpieces, particularly workpieces making up the structure of an aircraft (401). According to this example of embodiment, a control effector (460) receives a first laser head (410) of TEA CO2 type, known as excitation, to generate a photoelastic impulse on the surface of the workpiece (401), that is the subject of the testing. The CO2 laser is produced by a generator (400) and borne to the head (410) by the means (480) known from the prior art.

The control effector (460) also supports the laser head (411), known as detection, for measuring distortions of the surface in interferometry.

The control effector (460) is supported by a robotic arm (450) which allows the carrying out of scanning of the surface to test. A computerised device (470) allows to guide the movement of the robotic arm, to drive the reference laser amplifier, and to carry out the processing and the acquisition of the measurements. The guiding of the robotic arm is carried out from a digital description file of the surface of the tested workpiece (401), commonly from the digital model of the said workpiece.

FIG. 5, according to an embodiment of the method that is the subject of the invention, this invention includes a first step (510) involving the production of a photoelastic excitation on the surface of the workpiece to test, using the excitation laser. The response of the workpiece to this excitation is measured using the detection laser. According to a first step of measuring (520) the reference laser is adjusted (521) on a first level of intensity in order to carry out an interferometric measurement (511) with a bandwidth showing a low cut-off frequency around the MHz region. According to a second step of measuring (530) the reference laser is adjusted (522) on a second level of intensity, less than the first in this example of embodiment, in order to carry out a second interferometric measurement (512) with a bandwidth showing a low cut-off frequency less than the first. The laser beams are then moved (550) to another measurement point and the cycle of excitation measurement (510 to 530) is repeated anew.

The description above clearly shows that the invention reaches the targeted objectives, in particular it allows the achievement in an automated way, of a complete cartography of an assembled workpiece, combining measurements by ultrasound relating to material wholeness, or intrinsic faults, and to the cohesion of the assembly interfaces, according to a similar method in its principle of tap testing, but which brings to this testing method, the capacity of localisation and cartography of the cohesion faults.

1-9. (canceled)

10. A device for the non-destructive testing of a workpiece, in particular made from a fibrous reinforced composite material, characterised in that it includes:
a. generator known as excitation laser beam generator and means to produce a photoelastic stress pattern of the surface of the workpiece, in an excitation area, using said laser beam;
b. means for generating a first laser beam known as detection laser beam, suitable to illuminate the workpiece in a target area;
c. means for generating a second detection laser beam known as reference laser beam, one characteristic of which can be adjusted independently of the characteristics of the detection laser beam;
d. a two-wave photorefractive detector comprising a photorefractive crystal pumped by the reference laser beam;
e. means for collecting the beam reflected by the target area of the first detection laser, and conveying said beam into the photorefractive detector);
f. means of generation comprising a single source made up of a monolithic stabilised single-frequency oscillator, of the Nd:YAG type, pumped by diode, and two distinct amplifier lasers for generating, from this source, the detection laser beam and the reference laser beam;
g. wherein it includes means for modifying at least one characteristic of the reference laser so as to adjust the bandwidth of the photorefractive detector between a first low cut-off frequency, higher than 1 MHz, and a second low cut-off frequency, lower than 10 kHz.

11. Device according to the claim 10, wherein it includes scanning means to move the excitation laser beam and the first detection laser beam at the surface of the workpiece in order to carry out a scanning of its surface.

12. Device according to the claim 10, wherein the means of modifying the reference laser beam act on the intensity of said beam.

13. Device according to the claim 10, wherein it additionally includes a Fabry-Pérot confocal type interferometer.

14. A method for the testing of a workpiece, notably made from a fibrous reinforced composite material, using a device in accordance with claim 10, including the following steps:
a. producing a photoelastic excitation on the surface of the workpiece using an excitation laser;
b. measuring the response to this excitation in the target area illuminated by the detection laser beam, by pumping the photoreactive interferometer with a reference signal so that the measurement is carried out with a first low cut-off frequency higher than 1 MHz;
c. modifying the reference beam in order to carry out an interferometric measurement using the photorefractive interferometer with a second cut-off frequency lower than the first cut-off frequency;
wherein the illumination of the target area by the detection laser beam is continued during the steps a/ to c/.

15. Method according to the claim 14, wherein the second cut-off frequency is lower than or equal to 10 kHz.

16. Method according to the claim 14, wherein the intensity of illumination of the target area are constant during the steps a/ to c/.

17. Method for the testing of a workpiece, notably made from a fibrous reinforced composite material, using a device in accordance with claim 11, including the following steps:
a. producing a photoelastic excitation on the surface of the workpiece using an excitation laser;
b. measuring the response to this excitation in the target area illuminated by the detection laser beam, by pumping the photoreactive interferometer with a reference signal so that the measurement is carried out with a first low cut-off frequency higher than 1 MHz;
c. modifying the reference beam in order to carry out an interferometric measurement using the photorefractive interferometer with a second cut-off frequency lower than the first cut-off frequency;
wherein the illumination of the target area by the detection laser beam is continued during the steps a/ to c/, and wherein the steps a/ to c/ are repeated for a second point on the surface of the workpiece.

18. Method for the testing of a workpiece, notably made from a fibrous reinforced composite material, using a device in accordance with claim 13, including the following steps:
a. producing a photoelastic excitation on the surface of the workpiece using an excitation laser;
b. measuring the response to this excitation in the target area illuminated by the detection laser beam, by pumping the photoreactive interferometer with a reference signal so that the measurement is carried out with a first low cut-off frequency higher than 1 MHz;
c. modifying the reference beam in order to carry out an interferometric measurement using the photorefractive interferometer with a second cut-off frequency lower than the first cut-off frequency;
wherein the illumination of the target area by the detection laser beam is continued during the steps a/ to c/, and wherein it includes a step involving measuring the response of the workpiece in the target area with a Fabry-Pérot type interferometer with a low cut-off frequency lower than or equal to 1 MHz.
